(19) United States
(12) Patent Application Publication
(10) Pub. No.: US 2014/0074951 A1
(43) Pub. Date: Mar. 13, 2014

(54) ENHANCED CHAT FUNCTIONALITY AND SEARCHING

(71) Applicants: Paul Misir, Staten Island, NY (US); Vikas Singhal, New York, NY (US)

(72) Inventors: Paul Misir, Staten Island, NY (US); Vikas Singhal, New York, NY (US)

(21) Appl. No.: 14/023,816

(22) Filed: Sep. 11, 2013

Related U.S. Application Data
(60) Provisional application No. 61/700,018, filed on Sep. 12, 2012.

(51) Int. Cl. H04L 12/58

(52) U.S. Cl. CPC H04L 51/04
USPC 709/206

(57) ABSTRACT

Methods and systems for providing new functionality in chat applications are provided. In one embodiment, the new methods and systems associate commands with particular characters appearing in a chat message which instruct the chat application to perform certain protocols. In one embodiment, an application identifies a keyword in the chat message and performs an electronic search for data on the keyword. The search results may then be modified based on location; personal preferences and rankings, as well as preferences and rankings of the designated friends of the users involved in the online chat discussion.

### BACKGROUND

Online and telephony-based chat systems are popular among consumers worldwide. Known chat applications are limited to communicating the text of messages between users.

### SUMMARY

Methods and systems for providing new functionality in chat applications are presented. In one embodiment, these new methods and systems allow for fundamental changes in the way text is handled by a chat application by associating commands with particular characters appearing in a chat message. When received, these particular characters instruct the chat application to perform certain protocols. In one embodiment, an application identifies a keyword or phrase associated with the particular character or characters or otherwise appearing in the message and then performs an Internet, network, or other electronic search based on that keyword or phrase.

In a second aspect, the search functionality described above is specialized or customized so that results may be filtered and/or prioritized and ordered in accordance with criteria such as: geographic location; local time; whether a business entity, location, or other facility is presently open or closed (for instance to the public); and ratings associated with items in the search results.

In another aspect, the system search functionality described above filters and/or prioritizes and orders search results in accordance with a defined group of ratings associated with the items in the search results. The group of ratings may be the ratings provided or previously provided by people involved in the active chat conversation. The group of ratings may also be the ratings provided by a select group of users. The select group of users may include all of the users or the select group of users may be limited to one or more groups of users selected by one or more of the people involved in the active chat conversation. The select group of users may be limited to a group of users that equals the sum of the groups of users independently selected one or more of the people involved in the active chat conversation. The group of users may also be limited to those users who are logged on to the chat application or by the collective group of users having active accounts or profiles for the chat application. The ratings may exist independent of the chat application and may be provided, for example, by a separate application or database.

In another aspect, the methods and system operates as follows: within a conversation between users (for instance, and chat application or other electronic or online conversation, which may be limited to a total number of 20 users), a user signals sponsored search results simply by adding an “@” symbol at the end of the word (or another appropriate symbol). For instance, a user chatting with friends about dinner plans can place the “@” symbol after a food type (e.g., pizza) or other description and see nearby search results based on time of day, geo-location, group chat size, friends' social graph, and contextual data. This helps solve the “signal to noise” problem in delivering ads to mobile users by allowing users to trigger a search, and the results may be promotion based and/or also based on existing and immediate demand. The methods and systems also allow local (i.e. geographically relevant) businesses to participate in and become visible and available to users seeking at-the-moment or near immediate activities, shopping, purchasing or decision making.

Additional advantages and novel features of the present invention will be set forth in part in the description which follows and in part will become apparent to those skilled in the art upon examination of the following or may be appreciated further by practice of the invention.

### BRIEF DESCRIPTION OF THE DRAWINGS

Features and advantages of the present invention will become apparent to those skilled in the art from the following description with reference to the drawings, in which:

FIG. 1 is a block diagram showing an exemplary computing device in accordance with certain embodiments of the invention;

FIG. 2 is a block diagram showing an exemplary network environment for use with certain embodiments of the invention;

FIG. 3 is a block diagram showing another exemplary network environment for use with certain embodiments of the invention;

FIG. 4 is a flow chart for a method of handling instant messages or online chat messages in accordance with certain embodiments of the invention; and

FIG. 5 is a flow chart for a method of handling instant messages or online chat messages in accordance with certain embodiments of the invention.

### DETAILED DESCRIPTION

For simplicity and illustrative purposes, the principles of the present invention are described by referring mainly to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the true spirit and scope of the present invention. Before explaining the disclosed embodiments of the present invention in detail, it is to be understood that the invention is not limited in its application to the details of any particular arrangement shown, since the invention is capable of other embodiments. Throughout this description, certain acronyms and shorthand notations are used. These acronyms and shorthand notations are intended to assist in communicating the ideas expressed herein and are not intended to limit the scope of the present invention. Other terminology used herein is for the purpose of description and not of limitation.

### Added Functionality in Chat Applications

An exemplary application for the inventive methods and systems would be in the context of an online “chat” or instant messaging where two or more users are able to send and receive text messages with one another using a combination of hardware and software. Such methods and systems would allow for near-instantaneous transmissions of messages between a sender and a receiver. The communication is commonly quasi-synchronous or synchronous. These methods and systems include both point-to-point communications as well as communications from one sender to many receivers. The communication may be peer to peer or may involve a network or other hardware and/or software so that the communication is, for example, peer to network to peer.

In one embodiment, a command instruction is received as part of a message (for instance a text message) and a chat application takes action responsive to receipt of that command instruction. In this embodiment, the command instruction is or is designated by an alphanumeric or nonalphanumeric character or plurality of characters appended to a keyword, name or phrase as the keyword, name or phrase is provided to a chat application. For purposes of this disclosure it should be understood that the term keyword may and in some instances does include names and phrases, while not being limited thereto. When received by the chat application, the chat application recognizes the command instruction, transmits the message to the intended recipient(s), and performs some further action responsive to the receipt of the command instruction. In one embodiment, the command instruction causes execution of a search and then delivery of the search results to the users involved in the online chat. These search results are delivered, exclusively or nonexclusively, via the display function of the chat application.

The invention may operate in the general context of computer software code or machine-useable instructions, including computer-executable instructions such as program modules. These instructions are executed by a computer or other machine, such as a personal data assistant or other hand-held electronic device. The program modules include protocols, routines, programs, objects, components, data structures, etc., and refer to code that performs particular tasks or otherwise operates on data types. The inventive systems and methods described herein may be practiced on a variety of system configurations, including hand-held devices, consumer electronics, general-purpose computers, specialty computing devices, and other similar devices. The inventive concepts may also be practiced in networked environments, including distributed computing environments where tasks are performed by remote-processing devices that are linked through a communications network.

Computer-readable media include both volatile and nonvolatile (non-transitory) media, removable and nonremovable media, and contemplates media readable by a database, switch, and various other network devices. By way of example, computer-readable media includes, but is by no means limited to, media implemented in any method or technology for storing information. Exemplary stored information includes computer-useable instructions, data structures, program modules, and a variety of other data formats. Media examples include, but are not limited to, information-delivery media, RAM, ROM, EEPROM, flash memory or other memory technology, compact discs (CD), digital versatile discs (DVD), optical discs, magnetic tapes, magnetic disks as well as other magnetic storage devices. These technologies may store data momentarily, temporarily, or permanently.

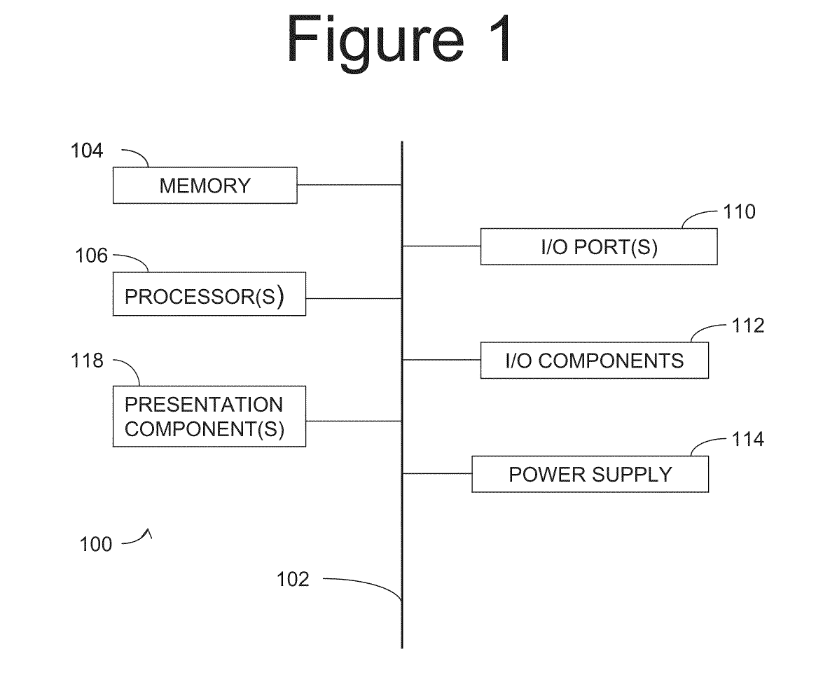

FIG. 1 displays a representation of an exemplary operating environment for implementing embodiments of the invention in the form of computing device 10. Computing device 10 is exemplary of a suitable computing environment and is not intended to and should not be read to suggest any limitation as to the scope of use or functionality of the invention.

Computing device 100 includes a bus 102 that directly or indirectly couples the following components: memory 104, one or more processors 106, one or more presentation components 108, input/output ports 110, input/output components 112, and a power supply 114. Bus 102 may be one or more busses (such as an address bus, data bus, or combination thereof). As one of skill in the art would appreciate, the various components shown in FIG. 1 may be merged and combined. For instance, a display device might serve as both an I/O component and a presentation component. Similarly, processors have memory. Thus, it is to be understood that FIG. 1 is merely illustrative of an exemplary computing device that can be used in connection with one or more embodiments of the invention. All categories of computing devices such as a “workstation,” “server,” “laptop,” “hand-held device,” etc., are contemplated and within the scope of FIG. 1 and referenced herein as a “computing device.”

Memory 104 includes computer-storage media in the form of volatile as well as nonvolatile (non-transitory) memory. This memory may be removable or nonremovable or a combination thereof. Exemplary hardware devices may include solid-state memory, hard drives, optical-disc drives, etc. Computing device 100 includes one or a plurality of processors 106 that read data from components such as memory 104 or I/O components 112. Presentation component(s) 108 present indications of data to a user or other device. Exemplary presentation components 108 include visual display devices, speakers, printers, etc. I/O ports 110 allow computing device 100 to be coupled with and in communication with other devices including other I/O components 112, which may be part of the computing device 100 itself. Illustrative I/O components 112 may include microphones, trackballs, scanners, cameras, printers, keyboards, touch sensitive devices, including touch sensitive screens, other interactive display devices, or a mouse.

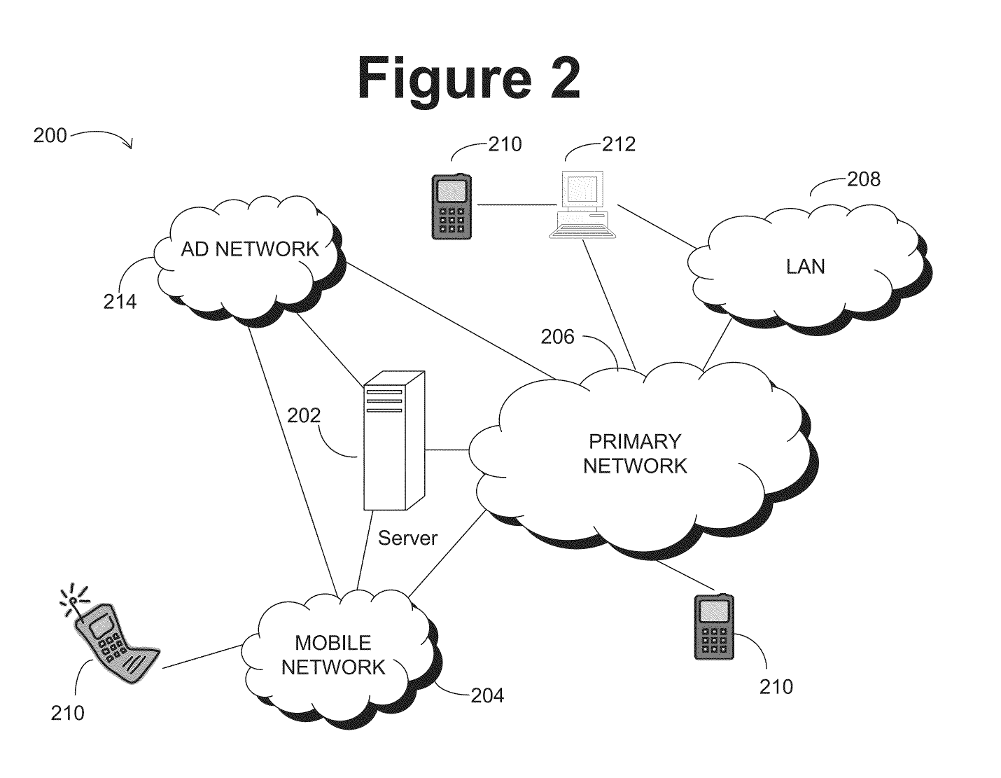

FIG. 2 shows a network environment 200 for implementing embodiments of the present invention. Network environment 200 includes a server 202, a mobile network 204, a primary network 206 and a local area network (LAN) 208. Mobile devices 210 communicate with server 202 via mobile network 204, primary network 206 and/or LAN 208. Network environment 200 is provided as an example of one suitable network environment and is not intended to and should not be read to suggest any limitation as to the scope or functionality of the present invention. Further, network environment 200 should not be interpreted to have any dependency on any single component shown in FIG. 2.

Server 202 can include a server or other computing device that can communicate content to other devices such as, for example, mobile device 210. In other embodiments, server 210 includes a network. Content may include, for example, documents, files, search results, applications, music, videos, scripts, streaming multimedia, data and similar items. In one embodiment, server 202 provides content to a mobile device 210 through a mobile network 204, primary network 206, or directly to the mobile device 210. In certain embodiments, server 202 is part of mobile network 204, primary network 206 and/or LAN 208, or a combination of any of the foregoing. In other embodiments, server 202 is independent of the other elements shown in FIG. 2.

Primary network 206 can include any kind of a variety of suitable networks such as, a LAN, a wide area network (WAN), the Internet, a cellular network, a peer-to-peer network, or a combination of such networks. In certain embodiments the primary network 206 is part of the Internet.

Mobile device 210 can be any suitable mobile device for presenting content to a user, and can include, for example, mobile devices that communicate regularly or periodically with mobile network 204 or primary network 206. In one embodiment, mobile device 210 may be a computing device such as, for example, computing device 100 of FIG. 1. In certain embodiments, mobile device 216 may include mobile devices such as a cellular phone, a personal digital assistant (PDA), smart phone, laptop computer, handheld computing device, and similar devices.

Computing device 212 may be any kind of computing device useful for communicating with a network 204, 206, and/or 208, and/or server 202. In one embodiment, computing device 212 may be a computing device such as, for example, computing device 100 of FIG. 1. Computing device 212 may be, for example, a personal computer (PC), a laptop computer, a notebook computer, a tablet computer, a PDA, a smart phone, a terminal or a similar device.

An optional ad network 214 may be provided to provide advertisement content to components within the network environment 200. Optionally, ad network 214 may be part of server 202, mobile network 204, primary network 206 and/or LAN 208, or a combination of any of the foregoing. In other embodiments, ad network 214 is independent of the other elements shown in FIG. 2. Optionally, ad network 214 is not present at all.

In one embodiment computing device 212 is a personal computer. Computing device 212 may configured for communicating with mobile device 210. Computing device 212 can, in some embodiments, use an application programming interface (API) or an application to communicate with mobile device 210 and update files, folders, play lists, and similar data structures on mobile device 210. In another embodiment, computing device 212 facilitates communication between mobile device 210 and network 204, 206, 208, or server 202. Thus, mobile device 210 can retrieve content, updates, media content, and advertisements from a server 202, or other entity associated with a network 204, 206, 208, or 214.

Mobile device 210 can include a memory that stores user profiles, game data, media content, or other content and is useful to allow a user to connect to other computing devices 212 such as other computers, media players, and similar devices. In a further embodiment, computing device 210 can be a terminal, public network access terminal, a media management system as may be available in a hotel room, or other device that can communicate with mobile device 210. In some embodiments, computing device 218 can communicate with one or more of the other elements illustrated in FIG. 2. For example, in one embodiment computing device 212 can communicate with ad network 214 and/or server 202, either directly or indirectly through a LAN 208 or other network 204 or 206.

According to an embodiment of the invention, data can be obtained from a mobile device 210 that provides information about the current location of mobile device 210. Location information about a mobile device 210 can be obtained in a number of different ways. For example, a component of mobile network 204 (e.g., a location server, a router, etc.) can determine a location associated with a mobile device 210 that communicates through mobile network 204. In some embodiments, location information is retrieved via global positioning system (GPS) technology. Alternatively, or additionally, triangulation techniques using multiple cell towers can be used to determine device location information. In further embodiments, satellite locating techniques can be utilized to determine location information for mobile device 210. Mobile network 204 can provide device location information to entities outside of mobile network 204 such as, for example, ad network 214, primary network 206, LAN 208, computing device 212, server 202, or mobile devices 210.

In one embodiment, mobile device 210 includes technology for determining its location or obtaining information associated with its location. Data or other information indicating the location of the mobile device 210 can be communicated from the mobile device 210 to another entity, or the data or information may be retrieved from mobile device 210. In a further embodiment, when a mobile device 210 communicates with another device, mobile device 210 may be associated with identifying information such as addressing information, presence information, and other similar information. For example, mobile device 210 can be associated with an internet protocol (IP) address, a MAC address, a network port, or any number of other types of addressing or locating information. IP addresses, MAC addresses, and others can be used to determine information about the location of mobile device 210. In some embodiments, mobile device 210 may use an address associated with a computing device 212, an ISP, a LAN 208, or similar device. In another embodiment, communications can be monitored to detect, record, and analyze address information, and other types of information relevant to location information for mobile device 210.

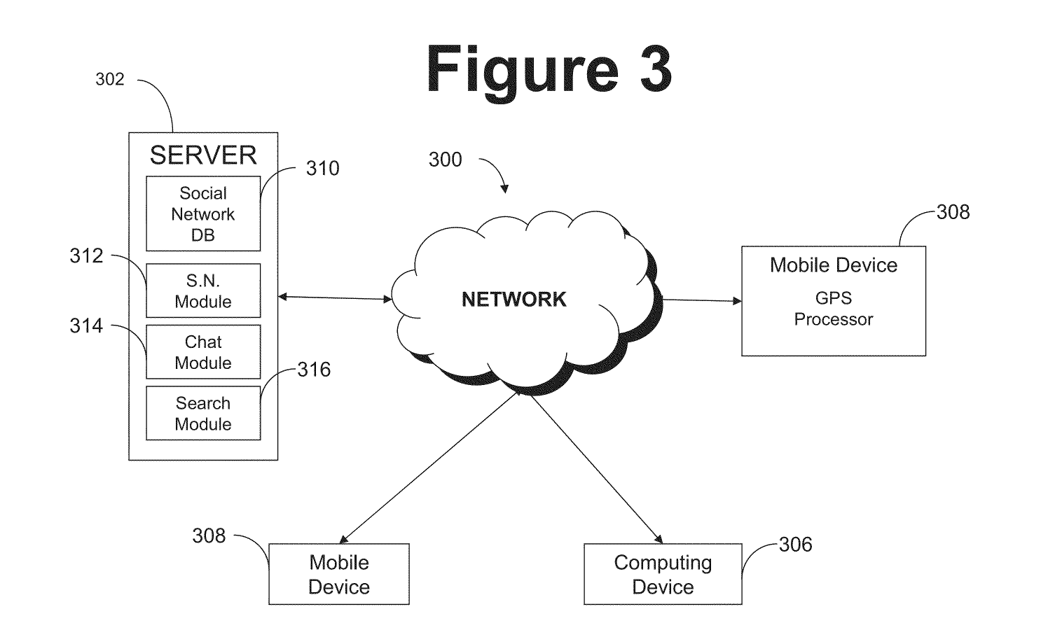

FIG. 3 shows another exemplary network environment 300 for implementing embodiments of the present invention. The network environment 300 may include a server 302 in communication with a network 304, which network 304 may be similar to networks 204, 206 or 208 described above. A chat application may be, for example, a software application provided through a server 302, computing device 306, or mobile device 308. In one embodiment the software application is accessed through a web browser. The server 302 may include social network database 310, social network module 312, chat module 314, and/or search module 316. Alternatively any one or of social network database 310, social network module 312, chat module 314, and/or search module 316 may be provided on a separate server (not shown), computing device 306, or mobile device 308. The modules associated with server 302 may be maintained on a single device, or they may be distributed across a plurality of devices for instance as cluster or other networked arrangement.

In one embodiment, the social network database 310 and social network module 312 includes components, servers, modules, or other technology and components to facilitate delivery, operation and/or presentation of a social network to users. The social network module 312 allows users to store profile information and to connect with other users. In one embodiment, each user is allowed to select and store a list of other users to be included within a user list specific to that user. As described below, when a particular user runs a search, profile information for the other users identified by that particular user may be shared and used in formulating and ranking the search results.

Social network module 312 also allows each user to rank or rate goods and services from a variety of businesses and restaurants. The ratings and rankings may be binary, for instance, “like” or “dislike.” Alternatively, the ratings and rankings may be scaled, for instance, each user may be able to provide a numerical representation of their opinion on the good, service, business, or restaurant on a predefined numerical scale. An example would be that each user could rank a business on a scale of 1 to 10. Alternatively, each user may rank a business, good, or service by assigning one or more stars or other indicia of a favorable opinion to the business, good, or service.

The chat module 314 allows users to chat with one another over a network, such as one or more of networks 204, 206, and 208 of FIG. 2. For instance, in one embodiment, the chat module 314 establishes a two-way TCP/IP connection between one or more mobile devices 308 and/or computing devices 306. The chat module may rely on a program such as ICQ or another suitable instant messaging service to provide dynamic group based (ADD) chat or instant messaging functionality.

The chat module 314 is configured to analyze each instant message and determine whether a command instruction is included in that message. The character or characters that indicate or serve as a command instruction may be predesignated or it may be selected by the user, in which case, the methods include a step of presenting a user with a choice to enter the character or characters for the command instruction and receiving a user's selection of a choice for the command instruction. In certain embodiments the character or characters for the command instruction are selected by a system operator or administrator.

In one embodiment, a user places the character or characters identifying a command instruction immediately before the first character in a keyword or immediately after the last character in a keyword. In this embodiment, the software recognizes the command instruction and extracts the keyword for further action. In another embodiment, the character or characters for a command instruction are provided anywhere in part of a chat message. The software recognizes command instruction and extracts a keyword or phrase for further action.

The command instruction may be entered by depressing buttons corresponding to numbers, letters or other characters, for instance on a keyboard or key pad. Alternatively, the command instruction may be voice activated. In certain embodiments of the invention, the chat functionality is voice activated and operated entirely or partially through speech recognition. In such an embodiment, the command may be spoken by the user and interpreted and understood by the software as the command instruction. For instance if the character identifying a command instruction is an “@” character, pronounced “at”, the user might identify the command instruction by speaking the phrase “keyword at” where the “keyword” operates as discussed herein. Such speech recognition techniques would be operative and is contemplated for online, SMS, text, and other forms of peer to peer messaging.

In another embodiment, the command instruction itself may identify the particular method, function or procedure to be performed with the keyword, for instance in the case of an embodiment where there are a plurality of commands associated with different characters. In one embodiment the command instruction may instruct the application to perform a particular task that does not require a keyword from the chat message.

Preferably the character or characters for the command instruction are non-alphabet and non punctuation so that they are not unintentionally used by a user as part of their chat message. The command instruction may be selected from the group of ASCII characters. Commonly the command instruction is one or more characters selected from the group of characters that are available for use on a standard computer keyboard. Suitable examples of non-alphabet, non-punctuation and non-numeric characters for use as a command instruction include any one or more of the following: @ # $ % ̂ * ( ) [ ] { } \ | / > <. In one embodiment the command instruction is identified by the symbol “@”.

In one embodiment, the function identified by the command instruction is to direct a search of the Internet or other networked computer system based on the keyword. Alternatively, the search may be based on a phrase entered along with the character or a portion of such a phrase. The choice between a search directed to a keyword and a search directed to a phrase in which the character appears may be made by a user based on the use of a particular character or characters for the command instruction.

In accordance with certain embodiments of the invention, a specific method, function or procedure is called when the software recognizes a particular character within or appended to the message. In one example, the particular character is included as the first or last character in a text word. In another embodiment the particular character can appear anywhere in the text message. The chat or instant messaging protocol is configured to detect the particular character and then extract a keyword or other collection of alphanumeric characters. The chat or instant messaging application then transmits the keyword or other collection of alphanumeric characters to a separate application for further processing.

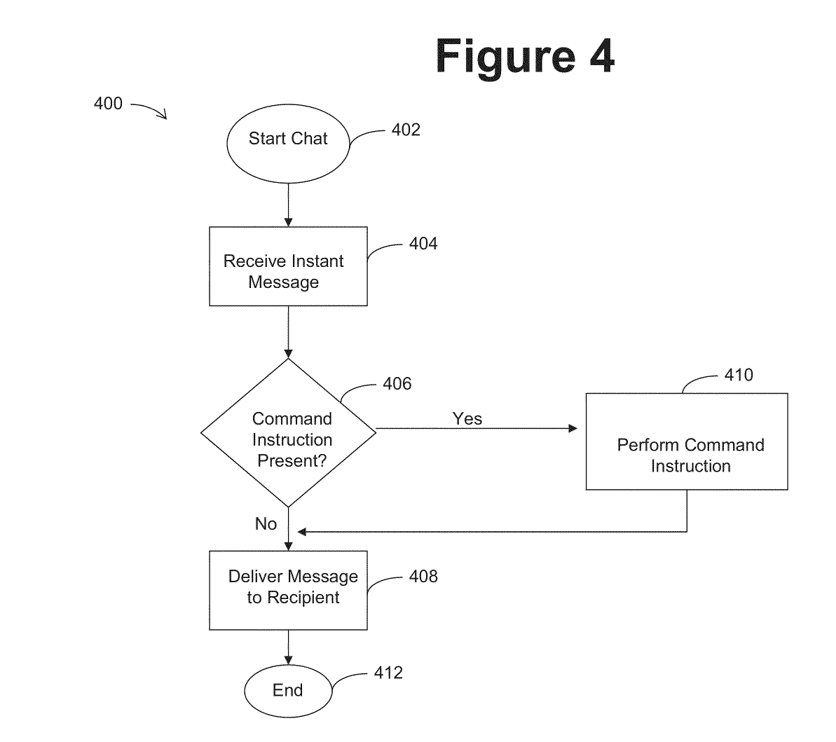

FIG. 4 shows a flowchart for a method in accordance with an exemplary embodiment of the invention. In FIG. 4, the method 400 begins with the start of or with an ongoing chat or online conversation 402. In step 404 an instant message or online communication is received by the chat module. Step 406 involves the chat module determining whether or not a command instruction is present. If step 406 indicates that a command instruction is present then the method proceeds to step 410 and the command instruction is performed. Step 410, performing the command instruction, may be performed by chat module, or by a combination of chat module and other software modules or applications, or chat module may simply pass the command instruction or a set of instructions to appropriate other software modules or applications.

In step 408 the method proceeds with delivering the instant message or online communication to the intended message recipient. Step 408 may follow step 406 directly, for instance when step 406 determines that no command instruction is present. Alternatively, step 408 may follow step 410. As would be appreciated by a person of skill in the art the order of steps 410 and 408 may be reversed, so that step 408, delivery of the message to the intended recipient, is performed before step 410, performing the command instruction. In another alternative, step 408, delivery of the message to the intended recipient, may be performed before step 406, determining whether or not a command instruction is present.

In one example, at step 410, the chat module transmits the command instruction and/or the keyword or phrase to a search application or module. For instance, the particular character used to call the search function may be an at symbol, “@”, sometimes also referred to as an ampersat or at mark. While in an online chat or instant messaging application a user might enter the message “What is the stock price of IBM@?” The online chat or instant messaging application would then recognize the number sign in the message and, in addition to passing the message on to the intended recipient user, also pass the message or a portion thereof to a search application.

The search application would then either run or instruct other application(s), such as a search engine, to search for and return information from the World Wide Web and/or FTP servers. The results of the search are then communicated back to the online chat application or instant messaging application for presentation to all of the users involved in the particular chat.

### Enhanced Search Functionality

In certain embodiments, the functionality that detects the presence of a particular predefined character is provided within an online chat, such as a web-based application or instant messaging application. Additionally an enhanced search application may be provided to interface with or between an online chat or instant messaging application and a search application or engine. The enhanced search application provides a variety of additional features, any number of which may be combined or offered individually.

For instance, in one embodiment, the enhanced search application will automatically target, filter, and rank the search results based on factors such as: (1) the geographic location of the searcher (the searcher being the user that entered the search function into the chat application) so that the search results are tailored to reflect the results that are geographically relevant to the searcher; (2) the local time at the location of the searcher and the open or closed status of local business in the geographic location of the searcher so that businesses that are not currently open are filtered out of the search results; and (3) ratings associated with the businesses in the search results, including whether overall popularity rankings or positive reviews, estimated costs.

Suitable location information may be identified through a location based system such as GPS or it may be determined based on the sender's previously-known location, or an indicator as to location determined from past usage or other historical data. Location information may also be input as part of the message and may be retrieved by the software from the content of the message or data associated therewith. In one embodiment the system will rely on GPS based location information as a default and will revert to historical data (such as the sender's previously-known location or most recently known location) or another location indicator (for instance historical data or data associated with or included within the message) in the event the GPS based information is unavailable (for instance if GPS functionality on a mobile device is turned off or unavailable).

In addition to the name of a business, public or private facility, location, etc. being included in search result, the search results may include a telephone number, address, estimated cost, review ranking (including number of and type of reviews, e.g., positive, negative, etc.). The filtered and ranked search results are provided to the online chat application or instant messaging application and the search results are presented to everyone involved in the chat. Additionally, the online chat application or instant messaging application is configured so that any of the search results may be selected by a user. Upon such selection by a user, for instance, selection of a business, the application will display a map which may showing walking or driving directions to the selected business. The application may show additional information relevant to the business, for instance, telephone number, address, a URL or plurality of URLs to the web site for the business, reviews of the business, in the case of a restaurant, a menu, a visual indicator representing the reviews of the business (for instance a series of stars with more stars indicating better reviews).

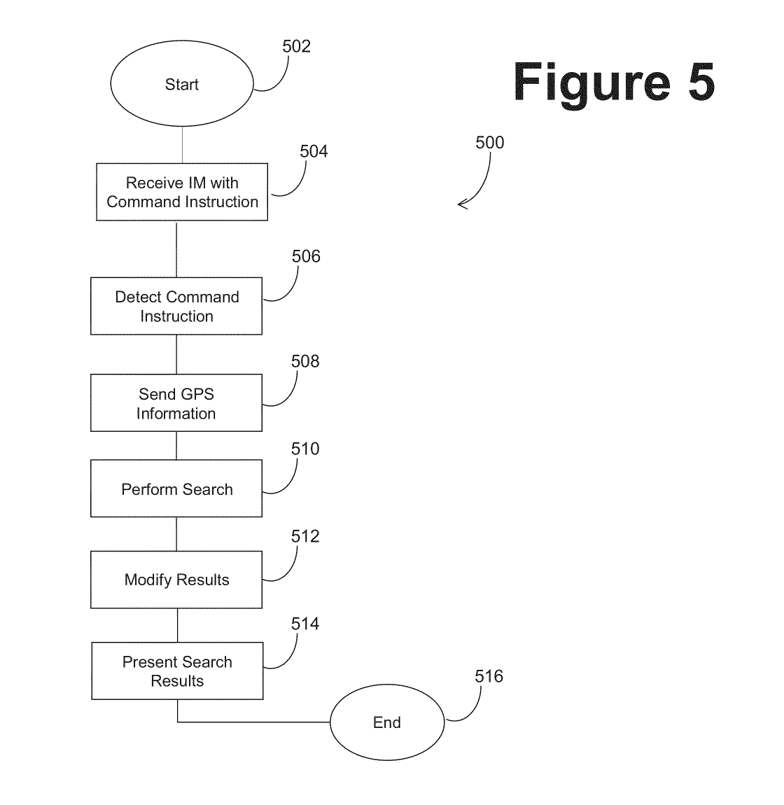

FIG. 5 shows a flowchart for another method 500 in accordance with an exemplary embodiment of the invention. The method of FIG. 5 starts at step 502. At step 504 an instant message or chat message is received. At step 506 the chat application or another module determines that the instant message or chat message includes a command instruction calling for a search for local restaurants. In step 508, the mobile device (such as a phone or other handheld device), or personal computer, used to send the command instruction provides the chat application, or another software module, with location information, for instance GPS information, for the device. The location information is provided to server, such as server 302 of FIG. 3, having at least one module. Alternatively, the location information is simply provided to a module such as social network module 312, chat module 314, and/or search module 316 of FIG. 3. Retrieving and sending the location information may be performed responsive to receipt of the command instruction at the mobile device or personal computer or it may be performed responsive to a separate instruction received from a module such as social network module 312, chat module 314, and/or search module 316 of FIG. 3.

In one embodiment, the location information is provided to search module 316 and subsequently a search is performed 510 based on (i) a keyword or phrase appearing in the instant message or chat message; and (ii) the location information for the user sending the instant message or chat message. In one embodiment, the method additionally includes the step of modifying the search results 512 to reflect ratings or other information provided from a social network such as social network module 312 of FIG. 3. Thus, in one embodiment the step of modifying the search results 512 involves prioritizing and/or ordering the search results based on ratings or other information appearing in the profile information in the social network module 312. The prioritizing and/or ordering may be limited to profile information appearing in the profiles of those users involved in the online chat or instant messaging conversation. In this way, the search results may be customized to the particular opinions, likes, dislikes or other ratings provided by the users involved in the online chat or instant messaging conversation.

In another embodiment, the step of modifying the search results 512 involves prioritizing and/or ordering the search results based on ratings or other information appearing in the profiles of others users appearing on one or more preselected lists of users. For instance, each user of the chat module may establish a social networking profile within the social network module and include information for that user. Such information may include that user's preferences for certain businesses, locations or other facilities, including local, regional, national or worldwide businesses. The information may include ratings or simple like or dislike information for particular businesses or other entities or places (for instance sports teams, publicly or privately owned places such as buildings, parks, beaches, etc.). The information may also include a list of one or more other users and the profile information for each of the one or more other users may also be used to customize search results. All of this information may be stored within a user's profile.

Thus, a search for a restaurant arising out of an online chat conversation between two users, for instance, A and B, may return search results reflecting not only A and B's preferences for restaurants, but also any preferences from other user profiles that either A or B had preselected. For instance if A had selected C, D, E, and F on her list of users, each of those other users' preferences, i.e. preferences from users C-F would also be used in formulating and ranking the search results. The number of user profiles that may be preselected for any given user may be predetermined. In one embodiment, each user may preselect a range of others users, for instance from 1 to 100. In another embodiment, each user may preselect 20 other users. In another embodiment, each user may preselect an unlimited number of other users.

In this way, the search functionality serves as an automated polling tool, where information provided by a user and stored in that user's profile impacts the results of searches that are run at a later date. This combination of features provides not only a new useful functionality for online chat and instant messaging, it will also drive additional online traffic to the social network interface, for instance, the social network website. This additional online traffic will include not only new users, who want to have their opinions counted, particularly in the online chat conversations that they are involved in, but also existing users, who will want to expand the scope of their profile to include more preferences and rankings and also to reflect the most up to date information for the existing preferences and rankings.

Additionally, or optionally, in addition to the criteria identified above, the search module filters and ranks the search results based on whether the businesses identified in the search are open or closed for business.

Once modified to reflect the various factors (location; opinions, rankings, or preferences from user profiles; local time and operating status (open or closed) of the businesses, facilities or places listed in the search results) the modified search results may then be presented 514 to the users involved in the ongoing chat or instant messaging session. In one embodiment, the modified search results are presented as a chat message or instant message.

While the invention has been described with reference to certain exemplary embodiments thereof, those skilled in the art may make various modifications to the described embodiments of the invention without departing from the true spirit and scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the spirit and scope of the invention as defined in the following claims and their equivalents.

We claim:

1. A computer implemented method for instant messaging comprising the steps of:
receiving, at a chat module, an instant message, including a command, the command identifying an instruction, wherein the instant message is sent from a sender to a recipient;
recognizing the command in the instant message;
performing the instruction identified by the command; and
delivering the instant message to the intended recipient.

2. The method of claim 1, wherein
the instruction identified by the command is to conduct a search of a database or the Internet based on one or more search terms appearing in the instant message and
the performing the instruction step includes causing a search module to perform a search of a database or the Internet and returning the search results to the sender and the recipient.

3. The method of claim 2, wherein the search module includes in the search terms information related to the location of the sender.

4. The method of claim 2, wherein the search module filters and ranks the search results based on opinion rankings from users selected for the sender's selected users list.

5. The method of claim 2, wherein the search module filters and ranks the search results based on whether the businesses identified in the search are open or closed for business.

6. The method of claim 3, wherein the information related to the location of the sender is determined based on the sender's previously known location, or an indicator as to location determined from past usage.
